(19) United States
(12) Patent Application Publication
(10) Pub. No.: US 2002/0006359 A1
(43) Pub. Date: Jan. 17, 2002

(54) MICROPLATE SAMPLE AND REAGENT LOADING SYSTEM

(75) Inventors: RICHARD A. MATHIES, BERKELEY, CA (US); PETER C. SIMPSON, BERKELEY, CA (US)

Correspondence Address: PILLSBURY MADISON & SUTRO, 725 SOUTH FIGUEROA STREET SUITE 1200, LOS ANGELES, CA, 900175443

(73) Assignee: AFFYMETRIX, INC.

(21) Appl. No.: 09/199,655

(22) Filed: Nov. 25, 1998

(51) Int. Cl. G01N 35/10

(52) U.S. Cl. 422/100; 436/180; 422/81; 422/99; 141/31; 141/116; 141/234; 141/237; 204/601

(57) ABSTRACT

Apparatus for forward and reverse transfer of fluids through capillaries, consisting of at least one capillary, a pressure generating or housing means, which preferably includes a box, having first and second means for aligning the capillaries from one set of wells to a second set of wells, and applied pressure differential transfers small amounts of liquid uniformly and in parallel. A method of accurately controlling a desired volume of fluid flow is particularly useful for transferring liquids to and from a microtiter dish to a Capillary Array Electrophoresis Microplate having liquid wells spaced in a radially symmetric configuration, or for maximizing desired transfer of the like or improved novel enhanced patterned arrays.

Research leading to portions of the present invention was funded in part by the National Institutes of Health and by the Department of Commerce through the National Institute of Standards and Technology.

### BACKGROUND OF THE INVENTION

1. Area of the Art

The present invention relates to methods and apparatus useful for small volume liquid transfer. In particular, the present invention relates to facilitating both forward and reverse parallel liquid transfer of aliquots of solutions from at least one reservoir, a set or array of reservoirs, to a different reservoir, set or array of reservoirs, as is especially useful in the context of systems for electrophoretic analysis, such as with Capillary Array Electrophoresis (“CAE”) Microplates.

2. Description of the Prior Art

Prominent among the conventional methods and apparatus for the transfer of liquids are robotic and the like automated systems. However, owing to cost and the lack of flexibility of such systems numerous drawbacks have arisen. Likewise, the trend toward automating and enhancing the efficiency of DNA mapping and sequencing technology has pushed the envelope of several related fields of art which have been synthesized serendiptiously by the present inventors to generate the unexpected results of the present invention.

By way of background, the utility of, and means for the detection of samples within capillary tubes using methods such as confocal microscopy are addressed by U.S. Pat. No. 5,091,652 (Mathies et al.) which issued on Feb. 25, 1992, to one of the present inventors.

U.S. Pat. No. 5,443,791 (“Cathcart et al.”); issued Aug. 22, 1995 and assigned to the Applied Biosystems Division of Perkin Elmer disclosed an Automated Molecular Biology Laboratory. The high cost and complexity of the robotic translation mechanism of this device differentiates the same from the teachings of the present invention.

Likewise, U.S. Pat. No. 5,770,157 (“Cargill et al.”); issued Jun. 23, 1998 to the Ontogen Corporation for Methods and Apparatus for the Generation of Chemical Libraries focused upon the costly and time intensive facilitation of robotic manipulation. Users of these kinds of systems continue to demand more flexibility and more cost efficiency, as demonstrated by the present invention.

U.S. Pat. No. 5,540,888 (“Bunce et al.”); issued Jul. 30, 1996 to the British Technology Group, Ltd., for Liquid Transfer Assay Devices is further representative of the state of the art. However, the Bunce et al. device requires first, second, third and fourth flow channels of porous material, in contradistinction to the present invention.

Application Specific Capillary Electrophoresis was disclosed by U.S. Pat. No. 5,372,695 (“Demorest”); held by Applied Biosystems, Inc., which issued on Dec. 13, 1994. This system addressed the need for application specific flexibility, but included a complex serving apparatus which impeded its commercialization. According to the present invention, any number of capillaries may be handled, and no need for the expensive serving apparatus required by Demorest arises owing to the speed and industrial efficiency inherent in the teachings of the present invention.

Alternately, disposable one-time use devices are known, such as that disclosed in U.S. Pat. No. 5,354,538 (“Bunce et al.”); issued Oct. 11, 1994. Nothing in the disclosure indicates that it can keep pace with known CAE Microplates, as is an important objective of the present invention.

U.S. Pat. No. 5,560,811 (“Briggs et al.”) issued Oct. 1, 1996 and is assigned to Seurat Analytical Systems, Inc. The subject matter is a method and apparatus for multiplexing electrophoresis analysis. Briggs et al. offers for consideration an excellent summary of the evolution of the instant technology and a thorough description of the state of the art. However, there is no teaching respecting the use of pressure differential gradients, and their impact upon the forward and reverse transfer of fluids through the subject capillaries. Likewise, although the number of arrayed capillaries is suggested to approach and exceed 96, no express teachings of a radial configuration is disclosed, as is according to the present invention.

In contradistinction to each of these known systems, the teachings of the present invention embrace and finally address the clear need for a liquid transfer system which is operationally functional at high speed, low cost, and with an enhanced efficacy over conventional disclosures. This system also permits the accurate dispensing of extremely small submicroliter volumes.

It is respectfully submitted that each of the discussed references merely define the state of the art, or highlight the problems addressed and ameliorated according to the teachings of the present invention. Accordingly, further discussions of these references is omitted at this time due to the fact that each of the same is readily distinguishable from the instant teachings to one having a modicum of skill in the art, as shall be denoued by the claims which are appended hereto.

### SUMMARY OF THE INVENTION

A microplate sample and reagent loading system transfers small μL or sub-μL volumes of liquid from one, or an array of liquid containing wells, to a second well or array of wells. A first end of an array of capillaries is placed into a solution in a first set of wells located inside of a pressurized chamber. A second end of the array of capillaries is arranged by a second manifold into a configuration corresponding to a second set of reservoirs. By the application of a predetermined amount of pressure for a predetermined amount of time, a small aliquot of liquid is transferred through each capillary in the array performing uniform transfer of a plurality of solutions in parallel.

The volume of the transferred solution is controlled by applying a controlled pressure and by precisely defining the time that the pressure is applied. Alternatively, the transfer could be driven by placing a second (or third) set of reservoirs in a second (or third, etc . . . ) chamber and transfer effected by applying a vacuum to each respective chamber. Likewise, eiterh forward or reverse vacuum pressure can be applied to the first pressure box to draw solutions into the wells which are contained therein.

Capture of a desired solution is effected, according to an embodiment of the instant teachings, by controlling the flow and fixing the same in a specific location by, for example, freezing a small plug of solution or by freezing a polymer or the like substance having a higher melting point than the solution. (Bevan, C. D., Mutton, I. M., “Use of Freeze-Thaw Flow Management for Controlling and Switching Fluid Flow in Capillary Tubes,” 1995, 67 Anal. Chem 1470-1473).

Advantageously, the pressure driven fluid transfer system of the present invention has the benefit of performing low volume, uniform liquid transfer and liquid processing in parallel and is expandable to any number of capillaries. Likewise, the system has the capability of transferring solutions from one arbitrary reservoir configuration to another.

Briefly stated, there is provided a method and apparatus consisting of at least one capillary, a pressure box having first and second means for aligning the capillaries from one set of wells to a second set of wells, and applied pressure or pressure differential transfers small amounts of liquid uniformly and in parallel. A method of accurately controlling a desired volume of fluid flow is particularly useful for transferring liquids from a microtiter dish to a Capillary Array Electrophoresis Microplate having liquid wells spaced in a radially symmetric configuration

According to a feature of the invention, there is provided a liquid-handling system for transferring liquid from at least one first container to at least one second container, which comprises; a means for applying pressure to a box containing at least one first container, at least one capillary tube having predetermined length and a predetermined internal diameter, wherein a first end of the predetermined tube is positioned near the bottom of said first container, the predetermined tube sealed through a wall of said box in a pressure-tight manner, and further extending to a predetermined second container and, means for increasing the pressure within the box, such that the liquid contained in the first container is transferred through said capillary tube to the second container when the pressure is raised within the box.

According to another feature of the invention, there is provided a method for using a liquid system for transferring a predetermined amount of said liquid from said first container holding a first volume of said liquid to said second container comprising the steps of calibrating said capillary tube by filling said first container with said liquid, filling said capillary tube with said liquid, increasing said pressure within said box to a predetermined pressure for a predetermined period of time to transfer a quantity of said liquid to said second container, measuring said quantity of said liquid thus transferred with a means for measuring; and, calculating the measured amount of liquid transferred per unit time, calculating the transfer time required to transfer said predetermined amount of liquid, and, increasing the pressure within said box to said predetermined pressure for said transfer time to transfer said predetermined amount of liquid from said first container to said second container.

Likewise, it is contemplated that the present invention encompasses dual vacuum creation means, located at either end of a capillary tube, or an array of the same. Further, it is noted that the instant teachings embrace the transfer of liquid by known, or developed pressure differentials being the driving force behind said transfers and multiple boxes or the like means for containing, including transfers driven by differential gravitational potentials.

### DESCRIPTION OF THE FIGURES

The above-mentioned and other objects, features and advantages of this invention and the manner of obtaining them will become more apparent, taken in conjunction with the accompanying drawings. These drawings depict only a typical embodiment of the invention and do not therefore limit its scope. They serve to add specificity and detail, in which:

FIG. 1 is a schematic of a microplate loading system according to an embodiment of the present invention;

FIG. 2 is a graphical depiction plotting displaced volume on the ordinate against time on the abscissa where the transfers have been driven by capillary loading systems which are embodiments of the present invention;

FIG. 3 is another schematic showing loading of a common reagent solution into multiple reservoirs according to an embodiment of the present invention;

FIG. 4 is an illustration of liquid capture using a cold plug according to embodiments of the present invention;

FIG. 5 is a schematic depiction of the flow of an air or liquid flow cavity according to embodiments of the present invention whereby a small region of the capillary array shown in FIG. 1 and FIG. 3 is heated or cooled;

FIG. 6 is an additional schematic showing solution removal and loading with a capillary array according to an embodiment of the present invention; and,

FIG. 7 is an illustration showing a method for simultaneous or sequential removal and loading from a capillary array according to an embodiment of the present invention.

### DETAILED DESCRIPTION OF PREFERRED EMBODIMENTS OF THE INVENTION

Heretofore undisclosed use of pressure differentials for the forward and reverse transfer of fluids through capillaries are disclosed according to the teachings of the present invention. Likewise, those skilled in the art will readily understand the utility of such teachings for use with rapidly evolving sampling technology for DNA and/or the like biomolecular species, compounds and/or substituent elements, moieties or structures.

The present inventors have discovered that preferred embodiments of present invention are utile in facilitating the revolution in separation science being effected by rapid and highly parallel electrophoretic analysis. (Simpson, P. C., Roach, D., Woolley, A. T., Thorsen, T., Johnston, R., Sensabaugh, G. F., & Mathies, R. A., 1998, 95 Proc. Natl. Acad. Sci. U.S.A. 2256-2261. Seiler, K., Harrison, D. J. & Manz, A. 1993 65 Anal. Chem., 1481-1488. This reference, and each other of the same cited herein, is expressly incorporated within the instant application by reference.).

CAE Microplates [as referenced above in Background of the Invention] are effective for performing extremely rapid electrophoretic separations of nucleic acids such as short tandem repeats (“STR”), single nucleotide polymorphism (“SNP”), restriction fragment length polymorphism (“RFLP”) and sequencing analysis, as well as amino acids and other analytes. (Woolley, A. T., Sensabaugh, G. F., & Mathies, R. A., 1997, 69 Anal. Chem. 2181-2186; Woolley, A. T., & Mathies, R. A., 1995, 67 Anal. Chem. 3676-3680; Schmalzing, D., Koutny L., Ziaugra, L. Matsudaira, P. & Ehrlich, D., 1997, 94 Proc. Natl. Acad. Sci. U.S.A. 10273-10278; Schmalzing, D., Koutny L., Ziaugra, L. Matsudaira, P. & Ehrlich, D., 1998, 70 AnaL Chem. 2303-2310.).

Likewise, the rapid pace now conventional under such mechanisms may be performed in time-spans as short as from about thirty seconds to about 2 minutes for fragment sizing, (Woolley, A. T., & Mathies, R. A., 1994, 91 Proc. NatL. Acad. Sci. U.S.A. 11348-11352) and from about 8 to about 20 minutes for sequencing. (Woolley, A.T. & Mathies, R. A., 1995, 67 Anal. Chem. 3676-3680; Schmalzing et. al., 1998, 70 Anal. Chem. 2303-2310.).

Prominent among the challenges of the development of CAE Microplate technology has been the need to load the microplates in a facile manner, that is rapid enough to keep up with the analysis speed of the micro-device. In some designs, the liquid wells on a CAE Microplate are spaced orthogonally on an 8×12 array, making them susceptible to use in conjunction with automated robotics. (Simpson, P. C., Roach, D., Woolley, A. T., Thorsen, T., Johnston, R., Sensabaugh, G. F., & Mathies, R. A., 1998, 95 Proc. Natl. Acad. Sci. U.S.A. 2256-2261.).

Problematic among robotic systems are the difficulties which arise with respect to mechanical complexity (and failure), pricing schemes, and the slow operation speed typical of such systems. (Watson, A., Smaldon, N., Lucke, R. & Hawkins, T. 1993, 362 Nature [London] 569-570; Hawkins, R. L., McKernan, K. J., Jacobot, L. B., Mackenzie, J. B., Richardson, P. M. & Lander, E. S., 1997, 276 Science 1887-1889; and Buxton, E. C., Westphall, M. Jacobson, W., Tong X. C. et al., 1996, 8 Laboratory Robotics and Automation 339-349.).

Turning now to FIG. 1, the basic format of a pressure loader according to an embodiment of the present invention is shown generally at 101. A first section 103 includes a means for sustaining a pressure gradient between solutions in contact with two ends to drive transport, as shown here as a pressure box assembly, which houses one end of an array of capillaries 107. A first manifold 105 properly spaces the capillaries and a solution to be transferred.

It will become readily apparent to those having a modicum of skill in the art that alternatives abound for the use as the means for sustaining a pressure gradient between solutions in contact with two ends to drive transport, preferably a pressure box. For example, one could simply place a plate on a microtiter sample dish sealed with o-rings and .apply pressure as well. By putting such a dish in a pressure box, a basic embodiment is illustrated, but is not intended to limit the teachings of the present invention, which may be amnifested in any number of ‘boxes’ or the liek containing/pressure gradient housing means.

Fused silica capillary array 107, is comprised of a multiplicity of individual capillaries 120 (or may be only one capillary 120), and makes up the second section of the illustrated embodiment of the present invention. Likewise, a second manifold 109 is effective for receiving capillaries and to space them into any desired spatial orientation, for example for a desired second well, or array of the same. In this illustrative embodiment, a CAE Microplate 111 is shown. Those having a modicum of skill in the art will readily understand that line 113 connects to a computer controlled pressure source, and that pressure box 103 includes conventional articles such as the illustrated microtiter dish 115.

Pressure box 103 further consists of a chamber in which fluid filled containers or liquid containing plates, such as conventional microtiter plates can be placed. One end of the capillaries extends through the top of the pressure box and are spaced by a manifold in a pattern that matches the layout of the reservoir.

As shown in FIG. 1, fused silica array 107 is illustrative of the instant teachings and those skilled in the art will readily understand how the fluid transfer system of the present invention consists of one or an array of capillaries through which the liquids are transferred. The volume of solution in the capillaries is determined by the inner diameter and the length of the respective capillary.

According to a preferred embodiment of the present invention, such a configuration of the loading system may be in a range of from about 30 cm long capillaries with 75 micron inner diameter and 200 micron outer diameter to an acceptable deviation therefrom. This gives the capillaries an internal volume of approximately 1.325 microliters. The system uses pulled glass capillaries with external polyamide coatings to transfer the liquids; however, any type of capillary or tube with the desired internal volumes can be used, including plastics, or Teflon, such as would be known to those skilled in the art. Thin wall metal or stainless steel capillaries could likewise be used.

Still referring to FIG. 1, the second manifold 109 functions as a capillary spacer, and the main function of this portion of the capillary loading system is to space the capillaries into an array that matches the spacing of the receiving reservoirs. The second manifold 109 is also used to maintain consistent height of the capillary ends to ensure uniform liquid dispensing.

Likewise, according to empirical data derived from preferred embodiments and known information for performance of the present invention operational algorithmic expressions further defining the instant teachings have been adduced by the present inventors. In sum, the flow characteristics of this system follow in accordance with theoretical calculations of low Reynolds number pipe flow. An equation for expressing such volumetric flow rate (Q), is described by Equation 1:

$$Q = \frac{π Δ {pr}^{4}}{8 µL} \qquad Eq . 1$$

Where Δp is the differential pressure between the two ends of the capillaries, r is the radius of the capillary, μ is the viscosity of the fluid and L is the length of the capillary. An equation for displaced volume (V) is linear with respect to time (t) and is shown by Equation 2:

$$V = \frac{π Δ {pr}^{4} t}{8 µL} \qquad Eq . 2$$

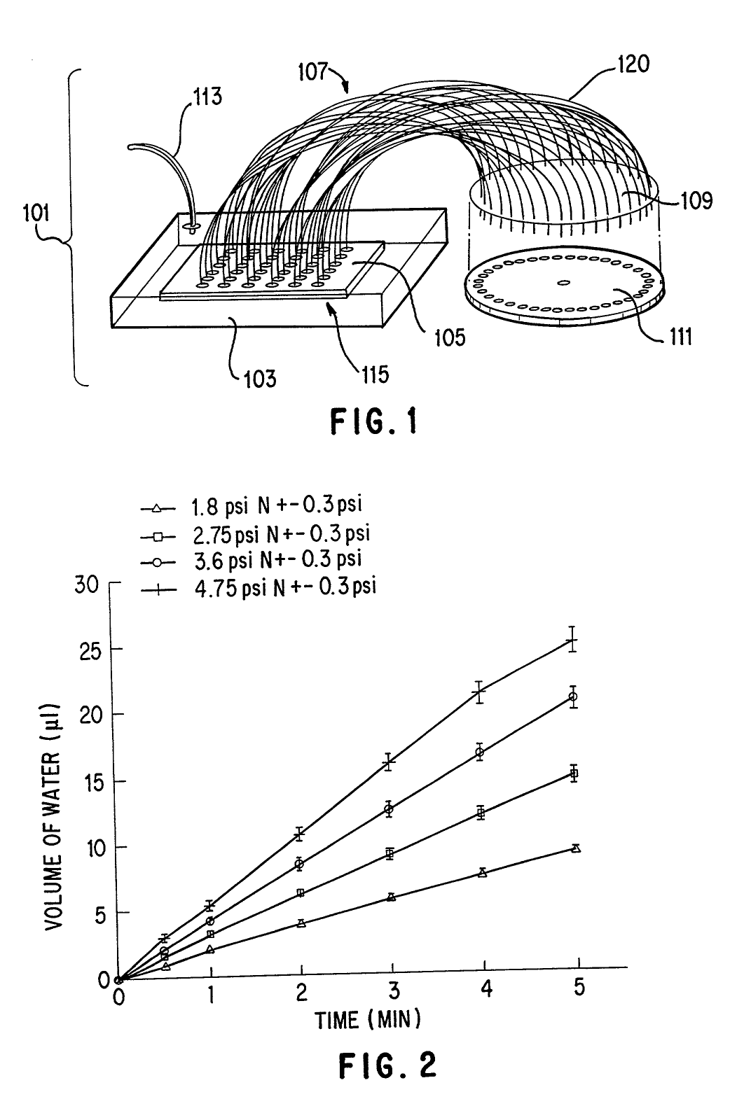

Referring now to FIG. 2, measurement of de-ionized H₂O displacement versus time for four different applied pressures on a 30 cm long, 75 micron inner diameter capillary is represented graphically. Volumes of water were collected from sets of three capillaries and weighted to calculate the volume and time as well as a linear relationship between the displaced volume and applied pressure, both of which follow theoretical predictions to fall within the expected range appropriate for experimental error. The capillary-to-capillary variance was measured in a similar manner as above. Two sets of data at different pressures (each set consisting of 6 groups of capillaries) were collected and measured, yielding a standard deviation of 3 to 4% of the collected volumes.

Among the inventive features of the present invention is an unprecedented capability for transferring solutions from one reservoir to multiple reservoirs. This loading methodology is likewise used to fill the cathode and waste reservoirs, utile for a variety of applications. For example, CAE microplates have been generated which use standard cross injectors on a 4 inch diameter substrate, use a single common anode reservoir thus reducing the needed reservoir count to 3N+1, and provide novel enhanced means for electrically addressing chips having from 12 channels up to 96 channels, or more.

Likewise, grouping of channels in different configurations, for example at the anode end, has facilitated a plurality of alternate CAE microplate designs, including those having an ability to be used with a linear confocal scanner. Such embodiments may employ, for example, 50 μm wide channels spaced apart 90 μm for a total array width of 1.1 to 1.2 mm. (Mathies, R. A., Simpson, P. C., & Woolley, A. T., “DNA ANALYSIS WITH CAPILLARY ARRAY ELECTROPHORESIS MICROPLATES,” Micro Total Analysis Systems '98, 13-16 October 1998, Proc of the μTAS '98 Workshop, 1-70.).

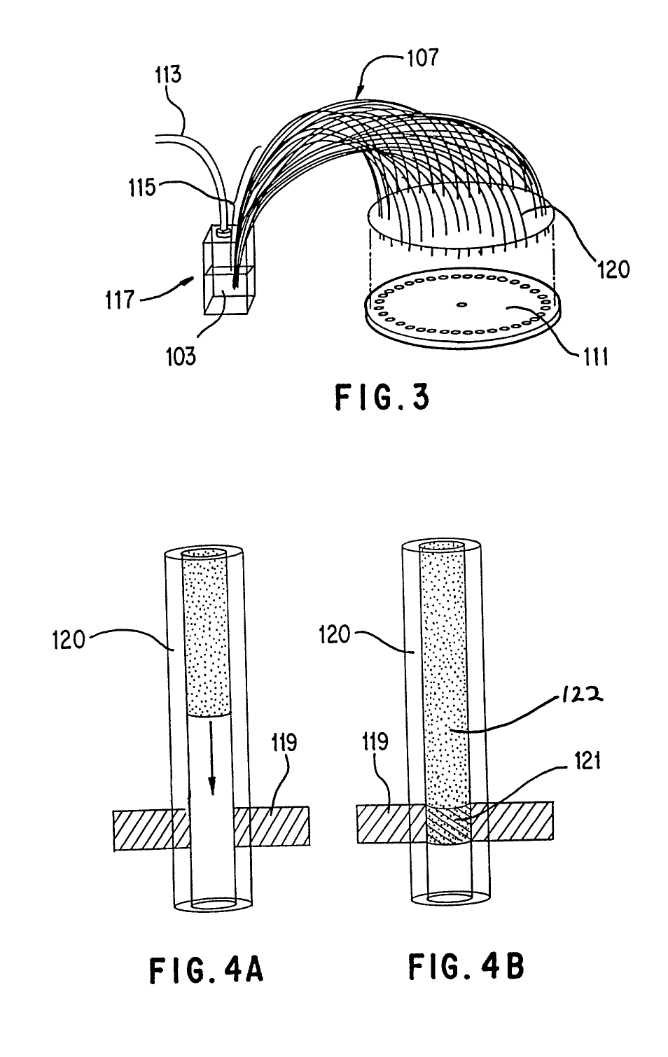

Referring now to FIG. 3, the present invention is effective to fill the cathode and waste reservoirs in the CAE Microplate 111 shown with a common buffer. According to this embodiment of the present invention, fused silica capillary array 107, is comprised of a multiplicity of individual capillaries 120 (or may be only one capillary 120), and in the illustrated embodiment is grouped into one reservoir 103 which is the pressure box, at the loading end 115 and laid out in an array corresponding to the cathode and waste reservoirs in the CAE Microplate.

Pressure is applied to the common loading reservoir 103 and equal amounts of buffer can be transferred to all of the waste reservoirs and/or cathodes in parallel. Fluid level is shown by arrow 117 in pressure box 103, and the line flowing to computer controlled pressure source 113 is likewise illustrated, but not shown.

Referring now to FIG. 4, the present invention further teaches liquid capture using temperature control, including liquid capture using a cold plug as shown in this schematic. FIG. 4A shows a situation according to the present invention where there is fluid flow, and FIG. 4B shows no fluid flow, owing to ice plug 121, lodged in capillary 120. It is noted that the FIG. 4B shows still fluid (not frozen) solution 122, and ice plug 121.

One of the longstanding challenges to uniform transfer of liquids through the capillaries is in the variability of liquid flow during the initial filling of the capillaries. It is know that such variability could be variously due to differences in the quality of the ends of the capillaries, the condition of the surface of the capillaries and/or blockage in the capillaries.

Once the capillaries are filled, the variability in filling rates decreases to an acceptable variance of about 3 to 4% standard deviation of the loaded volume. To ensure the capillaries are completely filled before dispensing the solution into the receiving reservoirs, a “capture” method can be used to stop the liquid flow near the end of the capillary. This can be accomplished by cooling a small region near the end of the capillary to below the freezing point of the liquid as demonstrated schematically in FIG. 4.

When the fluid reaches the cold region 122 defined by the capillary cooler 119, the front end of the solution will freeze and stop the flow of liquid. When all capillaries are filled with the tips frozen at the cold spot, pressure is removed and the temperature can be rapidly elevated to melt the ice plug. Pressure can be reapplied to dispense the fluid. The temperature can be controlled by several methods, including a Peltier cooling/heating system, resistive heating system, cryogenic fluid flow system or an air flow system.

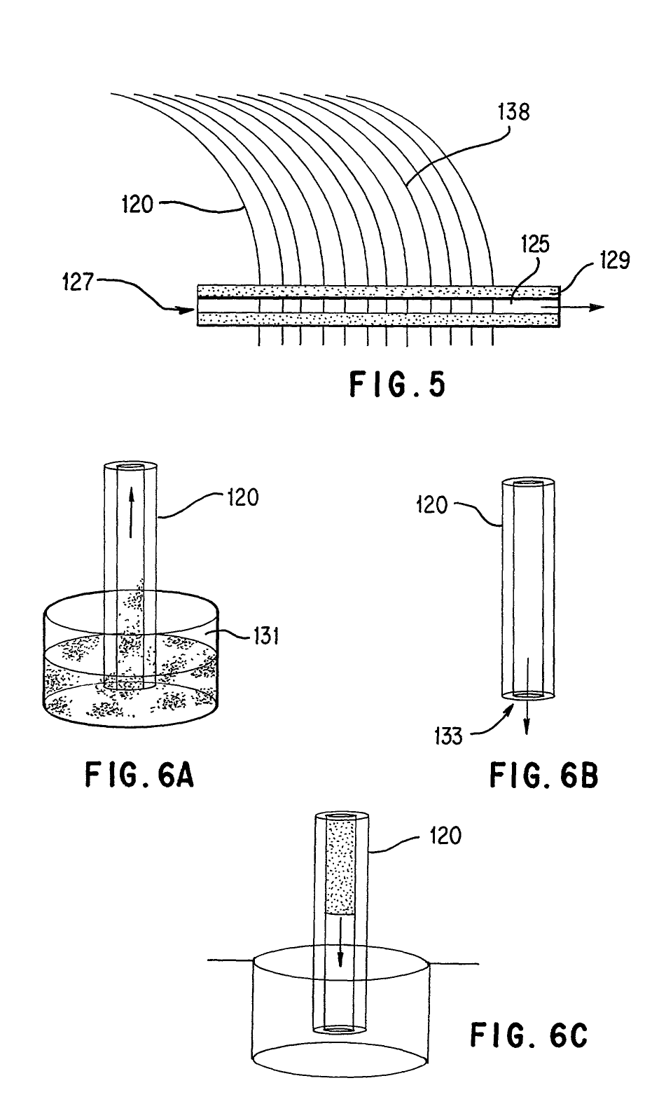

The air flow system, shown in FIG. 5, consists of a narrow air flow cavity 125 which contains a section of the capillary or capillaries 120. A continuous flow of temperature-controlled air passes through the chamber in the direction shown by the arrow at 127 to heat or cool the capillaries. The chamber can also be heated by hot water or cooled by liquid nitrogen, although several other cooling fluids or gases can be used. The chamber walls 129 are well insulated so that the temperature gradient in the capillary 120 is contained primarily to the thickness of the insulator.

The present invention further teaches other liquid stop methods. For example, another method of stopping the flow of the liquids is to use a bolus of a higher melting point fluid that will solidify when it enters the capillary. This can be a polymer or wax substance or immiscible inert fluid such as a fluorocarbon that floats on the top of a heated aqueous liquid. When all of the liquid is pressure filled through the capillary, the wax enters the capillary, cools and solidifies, stopping the fluid flow. The temperature of the capillary can also be controlled to allow the polymer through to a specific location within the capillary. Although there are advantages to using the polymer method, such as the ability to transfer liquid with zero dead volume, the frozen liquid plug method is advantageous because polymers may prove difficult to completely remove and can clog the capillary.

Lowering the pressure around the CAE microplate can also effect the primary transfer, and this is noted and dealt with by the instant teachings. Further vacuum cleanup, or transfer in either direction with involved liquid wells is contemplated by the inventors to be both necessary and within the scope of the claimed subject matter of the present invention. This is due to the fact that in some situations it is necessary to remove solutions from the CAE Microplate reservoirs before the new solution can be deposited into the reservoirs.

Referring now to FIG. 6, solution removal and loading with a capillary array is shown in three steps [labeled A, B and C for simplicity of illustration]. This schematic diagram demonstrates a method of applying a vacuum to the pressure box 103 (not shown) and sucking out the excess solution from reservoir 131 (A). The excess solution can be expelled from capillary 120 into a waste container located at 133, but not shown in step (B) and the desired solution can be deposited into the vacant liquid holes using the same capillary (C).

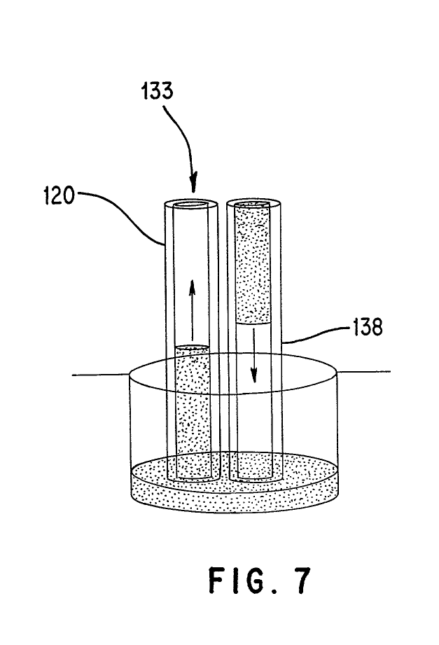

Referring now to FIG. 7, a two, or more, capillary per reservoir system can be used, for the simultaneous removal and loading from a capillary array. Each capillary 120 shown in FIG. 7 is used in accordance with this method, whereby one capillary 120 is used to vacuum remove the undesired liquids and the second 138 is used to deposit the new liquids. Vacuum removal of undesired solution in the direction of waste container 133 (not shown, but direction of travel is indicated by the arrow). Likewise, new solution from the microtiter plate (not shown, but direction of travel is indicated by the arrow) travels into second capillary 138 by means of the pressure fill of new solution. Likewise, one could also connect the microplate to three (or any desired number of) different boxes.

Further, it is understood that the invention includes embodiments where the array commencing from the microplate bifurcates and some of the capillaries go to a first pressure box which is used to deliver reagents to the microplate and other capillaries go to a second vacuum chamber that is used to remove fluids from the microplate, and the like arrangements or multiples attachments, appendages or complements such as would be within the scope of the appended claims.

Having described preferred embodiments of the invention with reference to the accompanying drawings, it is to be understood that the invention is not limited to those precise embodiments, and that various changes and modifications mat be effected therein by one of skill in the art without departing from the scope or spirit of the inventions defined in the appended claims.

What Is Claimed Is:

1. A liquid-handling system for transferring liquid back and forth from at least one first container to at least one second container, comprising:
a means for sustaining a pressure differential between solutions in contact with two ends to drive transport,
at least one capillary tube having predetermined length and a predetermined internal diameter, wherein a first end of said predetermined tube is positioned near the bottom of said first container, and extends to a predetermined said second container; and,
means for increasing the relative pressure within said means for sustaining a pressure gradient in contact with two ends to drive transport;
whereby at least one of said liquid contained in said first container is transferred through said capillary tube to said second container when said pressure gradient or difference is applied.

2. The system as defined in claim 1, wherein said predetermined tube is sealed through a wall of said means for sustaining a pressure differential between solutions in contact with two ends to drive transport in a pressure-tight manner, containing said at least one first container.

3. The system as defined in claim 1, whereby at least one of said liquid contained in said first container is transferred through said capillary tube by means of at least one of an intrinsic and an extrinsic vacuum source.

4. The system as defined in claim 1, further comprising:
a first capillary tube spacing means to position a first end of said at least one capillary tube near the bottom of said first container; and,
a second capillary tube spacing means to position a second end of said at least one capillary tube in a manner to deliver said liquid to said second container.

5. The system as defined in claim 4, wherein said first capillary tube spacing means is a first manifold and said second capillary tube spacing means is a second manifold.

6. The system as defined in claim 5, further comprising a plurality of said first containers deployed in a first array, and a plurality of said second containers deployed in a second array.

7. The system as defined in claim 6, further comprising:
a first translation subsystem means for transferring said first array in and out of said means for sustaining a pressure gradient between solutions in contact with two ends to drive transport, containing said at least one first container;
a second translation subsystem means for raising and lowering said first array;
a third translation subsystem means for moving, transferring, raising and lowering said second array; and
at least a supplemental means for moving, transferring, raising and lowering a microplate.

8. The system as defined in claim 7, further comprising computer means to control said first, second, and third translation means.

9. The system as defined in claim 1, wherein said at least one capillary tube is constructed of a material selected from the group consisting of pulled glass, pulled glass with an external coating, polyamide, polyethylene, polypropylene, polytetrafluoroethylene, polyester, PEEK(polyethylenetherketone), stainless steel and other chemically unreactive materials.

10. The system as in defined claim 9, wherein said means for raising said pressure within said means for sustaining a pressure gradient between solutions in contact with two ends to drive transport comprises a source of pressurized gas selected from the group consisting of air, nitrogen, argon, helium, combinations of the same and the like.

11. The system as defined in claim 10, wherein said pressure is at least one of raised to between about 0.5 lb. per square inch and about 10 lb. per square inch and drawn by a vacuum source having a predetermined force value.

12. The system as defined in claim 10, wherein said pressure is used with viscous fluids and is within a range of up to about 1000 psi.

13. The system as defined in claim 1, wherein said at least one capillary tube has a predetermined length selected from a range of about 10-100 cm. and has a predetermined inner diameter selected from a range of about 10-500 μ.m.

14. The system as defined in claim 1, whereby solutions are deposited and removed in either direction by at least one of sequential and parallel transport of said solutions from a well having at least two capillaries, including the deposit of two or more solutions to be mixed and removal of a resulting mixture by an additional capillary.

15. A method for transferring a predetermined amount of liquid to and from a first container holding a first volume of liquid to a second container and back comprising the steps of:
providing a means for sustaining a pressure gradient between solutions in contact with two ends to drive transport;
at least one capillary tube having predetermined length and a predetermined internal diameter, wherein a first end of said predetermined tube is positioned near the bottom of said first container, and extends to a predetermined said second container; and
means for increasing the pressure differential between the two ends, whereby said liquid contained in said first container is transferred through said capillary tube to said second container when at least one of said pressure gradient or difference is applied;
(a) calibrating said capillary tube;
(b) calculating the transfer time required to transfer said predetermined amount of liquid; and
(c) increasing the pressure within said box to said predetermined pressure for said transfer time to transfer said predetermined amount of liquid from said first container to said second container when said pressure gradient or difference is applied.

16. A method according to claim 15, wherein said means for sustaining a pressure gradient between solutions in contact with two ends to drive transport is preferably a pressure box for containing said at least one first container, and said calibrating step further comprises the steps of:
filling said first container with said liquid;
filling said capillary tube with said liquid;
increasing said pressure within said box to a predetermined pressure for a predetermined period of time to transfer a quantity of said liquid to said second container;
measuring said quantity of said liquid thus transferred with a means for measuring; and,
calculating the measured amount of liquid transferred per unit time

17. A method according to claim 16, wherein said predetermined tube is sealed through a wall of said box in a pressure-tight manner.

18. A method according to claim 16, whereby a pressure differential is effected by means of at least one of an intrinsic and an extrinsic vacuum source.

19. A method for using the system of claim 14 for transferring a defined amount of liquid from said first container holding a first volume of liquid to said second container comprising the steps of:
(a) calibrating said capillary tube;
(b) using said system to deliver defined amounts by:
filling said first container with liquid;
cooling with means for cooling said second end of said capillary tube to below the freezing point of said liquid;
increasing the pressure within said means for sustaining a pressure differential between solutions in contact with two ends to drive transport, whereby liquid fills said capillary tube and forms a frozen plug upon reaching said second end;
thawing said frozen plug with heating means; and
increasing the pressure within said means for sustaining a pressure differential across said tube whereby liquid is expelled from said capillary tube and delivered to said second container.

20. The method of claim 19, said calibrating step further comprises:
filling said first container with liquid;
cooling with means for cooling said second end of said capillary tube to below the freezing point of said liquid;
increasing the pressure differential across said tube, whereby liquid fills said capillary tube and forms a frozen plug upon reaching said second end;
thawing said frozen plug with heating means;
increasing the pressure within said whereby liquid is expelled from said capillary tube; and,
determining said defined amount by measuring with a measuring means the liquid thus expelled;

21. The method as in claim 14 wherein said cooling means is a member selected from the group consisting of Peltier cooling systems, cryogenic fluid flow systems, liquid nitrogen, liquid air, liquid helium, chilled gases, ice, and solid carbon dioxide; and wherein said heating means are a member selected from the group consisting of Peltier heating systems, resistive heating systems, air flow systems, and hot water.

22. A method for stopping and starting the flow of a liquid in the capillary tube of the system of claim 1, said method comprising:
(a) floating, on the surface of said liquid in said first container, a chemically inert liquid substance having a freezing point above the freezing point of said liquid in said first container and a density below the density of said liquid in said first container;
(b) cooling with means for cooling at least one of said first and second end of said capillary tube to below the freezing point of said chemically inert substance;
(c) increasing the pressure differential across the tube whereby liquid fills said capillary tube, and flows through until said inert substance forms a frozen plug upon reaching said second end.

23. The method as defined in claim 15, whereby a fixed closed volume is defined through the definition or two spatially separate frozen zones, which fixed closed volume may be subject to other reactions.

24. The method as defined in claim 14, wherein said means for measuring are at least one means selected from a means for measuring volume and a means for measuring weight.

25. The method as defined in claim 15, wherein said means for measuring are at least one means selected from a means for measuring volume and a means for measuring weight.

26. The method as in claim 15 wherein said cooling means is a member selected from the group consisting of Peltier cooling systems, cryogenic fluid flow systems, liquid nitrogen, liquid air, liquid helium, ice, and solid carbon dioxide; and wherein said heating means are a member selected from the group consisting of Peltier heating systems, resistive heating systems, gas flow systems, and hot water.

27. The method as in claim 14 wherein said substance is a member selected from the group consisting of waxes, polymers and fluorocarbons.

28. A method for using the system as defined in claim 14, wherein said system further comprises a waste container, whereby said liquid that has been transferred to said second container is transferred to said waste container, comprising the steps of:
(a) positioning said second end of said capillary to the bottom of said second container;
(b) decreasing said atmospheric pressure within said box to transfer said liquid from said second container to said capillary;
(c) positioning said second end of said capillary over said waste container;
(d) increasing said atmospheric pressure within said box to transfer said liquid in said capillary to said waste container.

29. A method as defined in claim 26, wherein a volumetric flow rate (Q) is excerised in at least one of a forward and reverse direction as described by Equation 1:
$$Q = \frac{π Δ {pr}^{4}}{8 µL} \qquad Eq . 1$$
Where Δp is the differential pressure between the two ends of the capillaries, r is the radius of the capillary, μ is the viscosity of the fluid and L is the length of the capillary; and the displaced volume (V) is linear with respect to time (t) and is shown by Equation 2:
$$V = \frac{π Δ {pr}^{4} t}{8 µL} \qquad Eq . 2$$

30. The method as defined in claim 19, said cooling step further comprising a controlling freezing location located between the first and second ends of said capillary.
